(19) United States
(12) Patent Application Publication
(10) Pub. No.: US 2010/0064025 A1
(43) Pub. Date: Mar. 11, 2010

(54) Method and Apparatus for Providing Media Service

(75) Inventors: Matti Johannes Nelimarkka, Helsinki (FI); Karl-Gustav Ots, Tampere (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/557,157

(22) Filed: Sep. 10, 2009

Related U.S. Application Data
(60) Provisional application No. 61/095,727, filed on Sep. 10, 2008.

(51) Int. Cl. G06F 15/16; G06F 17/00

(52) U.S. Cl. 709/217; 715/202

(57) ABSTRACT

In accordance with an example embodiment of the present invention, a user terminal may be configured to receive a media presentation over a first connection, render the media presentation, request over the first connection media content related to the media presentation, and receive a media content over a second connection.

### RELATED APPLICATION

This application claims priority to U.S. Provisional Application No. 61/095,727 filed Sep. 10, 2008, which is incorpoated herein by reference in its entirety.

### TECHNICAL FIELD

The present application relates generally to providing media service.

### BACKGROUND

The modem communications era has brought about an expansion of media services available on wireline and wireless networks. For example, computer networks, television networks, and telephony networks are experiencing an unprecedented technological expansion, fueled by consumer demand. Wireless and mobile networking technologies are addressing related consumer demands, while providing more flexibility to media services.

### SUMMARY

Various aspects of the invention are set out in the claims.

In accordance with an example embodiment of the present invention, a method comprises receiving a media presentation over a first connection, rendering the media presentation, requesting over the first connection media content related to the media presentation, and receiving a media content over a second connection.

In accordance with another example embodiment of the present invention, an apparatus comprises a receiver module configured to receive a media presentation over a first connection, a presentation module configured to render the media presentation, the transmission module further configured to request over the first connection media content related to the media presentation, and the receiver module further configured to receive a media content over the second connection.

In accordance with another example embodiment of the present invention, a method comprises receiving a media presentation request with user information, selecting a media presentation based on the user information, delivering the media presentation, receiving a media content request related to the media presentation, and delivering the media content according to the user information.

In accordance with another example embodiment of the present invention, an apparatus comprises a receiver module configured to receive a media presentation request with user information, a search module configured to select a media presentation based on the user information, a delivery module configured to deliver the media presentation, the receiver module further configured to receive a media content request related to the media presentation, and the delivery module further configured to deliver the media content according to the user information.

In accordance with another example embodiment of the present invention, a method comprises receiving a connection request, determining user information from the connection request, delivering a media presentation, receiving a media content request related to the media presentation, and delivering a media content according to the user information.

In accordance with another example embodiment of the present invention, an apparatus comprises a receiver module configured to receive a connection request, a connection handling module configured to determine user information from the connection request, a delivery module configured to deliver a media presentation, the receiver module further configured to receive the media content request related to the media presentation, and the delivery module further configured to deliver a media content according to the user information.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting a communication network system according to an example embodiment of the invention;

FIG. 2 is a flow diagram illustrating an example method for providing media service according to an example embodiment of the invention;

FIG. 3 is a block diagram depicting a user terminal according to an example embodiment of the invention;

FIG. 4 is a block diagram depicting a communication access node according to an example embodiment of the invention;

FIG. 5 is a block diagram depicting a media service node according to an example embodiment of the invention;

FIG. 6 is a flow diagram illustrating an example method for providing media service according to an example embodiment of the invention;

FIG. 7 is a flow diagram illustrating an example method for providing media service according to an example embodiment of the invention; and

FIG. 8 is a flow diagram illustrating an example method for providing media service according to an example embodiment of the invention.

### DETAILED DESCRIPTION OF THE DRAWINGS

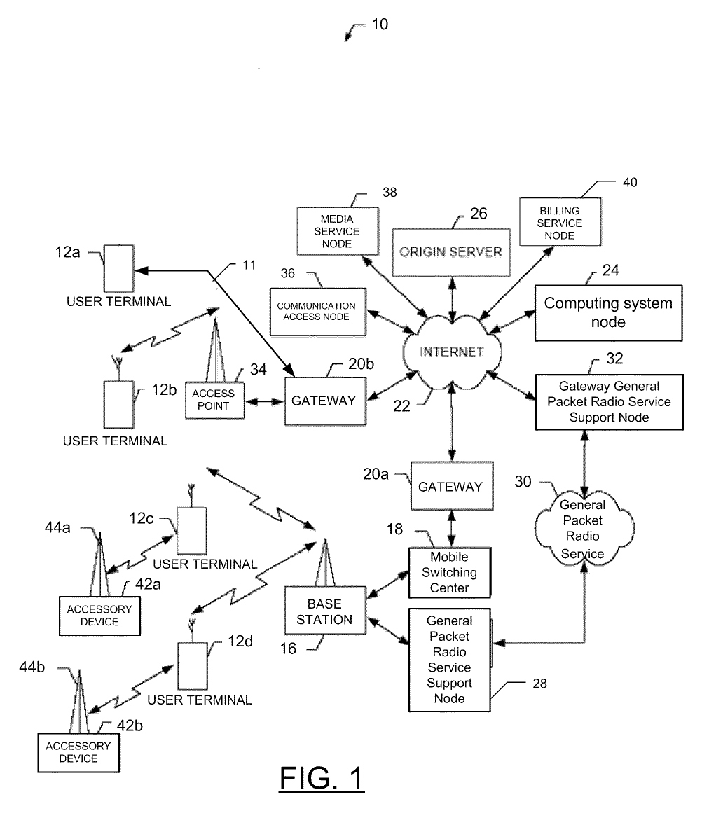

An example embodiment of the present invention and its potential advantages are best understood by referring to FIGS. 1 through 8 of the drawings.

FIG. 1 is a block diagram depicting a communication network system 10 according to an example embodiment of the invention. FIG. 1 provides an example embodiment of the communication network system 10, which may be configured to provide media service to electronic devices, such as user terminals 12a-d. In this example embodiment, one or more user terminals 12a-d may transmit signals to and receive signals from, for example, a base station (BS) 16, one or more gateways (GTW) 20a-b, an access point (AP) 34, and/or the like.

In an example embodiment, the BS 16 may be part of one or more cellular or mobile networks, in the communication network system 10. The communication network system 10 may comprise elements used to operate the network, such as a mobile switching center (MSC) 18. In an example embodiment, the BS 16 may also communicate with a signaling general packet radio service (GPRS) support node (SGSN) 28.

In an example embodiment, the MSC 18 may route telephonic calls, data calls and/or the like to and from the user terminals 12c-d. The user terminals 12c-d may be configured to make and receive telephonic call and/or data call to provide the media service. The MSC 18 may also be configured to provide a connection to a landline trunk during a user terminals 12c-d call. In an example embodiment, the MSC 18 may control forwarding of one or more messages, such as a short message service (SMS) message or multimedia service (MMS) message to and from the user terminals 12c-d to provide the media service. Further, the MSC 18 may also control the forwarding of one or more messages for the user terminal 12c-d to and from a messaging center. In an example embodiment, the MSC 18 may control the forwarding of one or more command prompts and one or more commands to and from the user terminals 12c-d to provide media service. Further, it should be understood that also user terminals 12a-b may work in a similar manner than the user terminals 12c-d.

In an example embodiment, the MSC 18 may communicate with a data network, such as a local area network (LAN), a metropolitan area network (MAN), a wide area network (WAN), such as Internet 22, and/or the like. In an example embodiment, the MSC 18 may also communicate with a gateway (GTW) 20a. The GTW 20a may communicate with the LAN, the MAN, the WAN, and/or the like. Further, devices, such as one or more processing or service elements, e.g., a personal computer, server computer, service provider, service node, data repository, data base, and/or the like, may communicate with the user terminals 12c-d via the Internet 22. Further, the one or more processing or service elements may be associated with a computing system node 24, an origin server 26, a communication access node 36, a media service node 38, a billing service node 40, and/or the like.

It should be understood that although the MSC 18 is shown in the communication network system 10, the MSC 18 is provided merely for illustrative purpose and embodiments of the invention are not limited to employing the MSC 18.

In an example embodiment, the SGSN 28 may operate in a substantially similar manner as the MSC 18 to provide the media service. For example, the SGSN 28 may directly or indirectly communicate with a data network, such as the Internet 22. In an example embodiment, the SGSN 28 may communicate with a packet-switched core network, such as a GPRS core network. The packet-switched core network may also communicate with a GTW GPRS support node (GGSN) 32. The GGSN 32 may communicate over the Internet 22 with a messaging center. Further, the GGSN 32 and the SGSN 28 may manage the forwarding of one or more messages, such as SMS or MMS messages to provide the media service. The GGSN 32 and/or SGSN 28 may also control the forwarding of messages for the user terminals 12c-d to and from the messaging center. Further, the GGSN 32 and/or SGSN 28 may manage the forwarding of one or more command prompts and one or more commands to and from the user terminals 12c-d to provide the media service.

In an example embodiment, by coupling the SGSN 28 to the GPRS core network 30 and the GGSN 32, devices, such as the computing system node 24, origin server 26, communication access node 36, media service node 38 and/or the billing service node 40, may communicate with the user terminals 12c-d to provide the media service. In an example embodiment, by connecting the user terminals 12a-b, the computing system node 24, the origin server 26, the communication access node 36, the media service node 38 and/or the billing service node 40 directly or indirectly to the Internet 22, the media service may be provided to the user terminals 12a-b.

In an example embodiment, the user terminals 12a-d may communicate with one or more different networks to provide the media service. The network(s) may support communication in accordance with multiple protocols, such as for example a first-generation (IG), narrow-band Advanced Mobile Phone System (NAMPS), Total Access Communication System (TACS), second-generation (2G), Interim Standard 136 (IS-136), Time Division Multiple Access (TDMA), Global System for Mobile communications (GSM), Interim Standard 95 (IS-95), Code Division Multiple Access (CDMA), two and half-generation (2.5G), GPRS, Enhanced Data GSM Environment (EDGE), third-generation (3G), Universal Mobile Telephone System (UMTS), Wideband Code Division Multiple Access (WCDMA), 3.9 generation (3.9G), fourth generation (4G), Long Term Evolution (LTE), future mobile communication protocols, and/or the like. In an example embodiment, the user terminals 12a-d may also communicate with one or more different devices and networks through a public switched telephone network (PSTN) 11.

In an example embodiment, the user terminals 12a-b may further communicate with one or more access points, such as the wireless AP 34, wireless or fixed gateway (GTW) 20b, and/or the like, to provide the media service. The AP 34 may communicate with a user terminal, such as the user terminal 12b, in accordance with one or more wireless short range communication techniques. Further, the AP 34 may communicate with the Internet 22 or any other network directly or indirectly. The GTW 20b may comprise access points configured to communicate with the user terminals 12a-b using different techniques, such as a Transmission Control Protocol/Internet Protocol (TCP/IP) over the PSTN. Further, it should be understood that also the user terminals 12c-d may work in a similar manner than the user terminals 12a-b.

In an example embodiment, the one or more access points, such as the AP 34 and the one or more gateways, such as the GTW 20b, may route telephonic calls and/or data calls to and from the user terminals 12a-b. The one or more access points may also provide a connection to a landline trunk during telephonic call and/or data call of the user terminals 12a-b. In an example embodiment, the one or more access points may control the forwarding of one or more messages, such as SMS, MMS, email messages, and/or the like, to and from the user terminal 12a-b. Further, the one or more access points may control the forwarding of one or more command prompts and one or more commands to and from the user terminals 12a-b.

In an example embodiment, the user terminals 12a-d, the computing system node 24, the origin server 26, the communication access node 36, the media service node 38, the billing service node 40, and/or the like may communicate with one another, to thereby carry out various operations, such as for example to provide the media service. In an example embodiment, the terms “data,” “content,” “information”, “service”, “media”, “media service”, “media content”, “media file”, “media content service”, “media presentation” and similar terms may be used interchangeably to refer to data capable of being transmitted, received and/or stored. Use of any such terms should not be taken to limit the spirit and scope of the present invention.

In an example embodiment, the user terminals 12a-d, computing system node 24, origin server 26, communication access node 36, media service node 38, billing service node 40 and/or the like may communicate with each other using different wireless short range communication techniques and/or wireline or wireless communication techniques. Further, one or more of the computing system nodes 24, communication access nodes 36, media service nodes 38 and/or billing service nodes 40 may comprise one or more removable or fixed memory units capable of storing media content, which may be transferred to the user terminals 12a-d.

In an example embodiment, the user terminals 12c-d may communicate with one or more accessory devices 42a-b. The one or more accessory devices 42a-b may be equipped with communication transceivers 44a-b. The user terminals 12c-d may be configured to communicate with the accessory devices 42a-b using the one or more wireline or wireless communication techniques, such as the wireless short-range communication techniques. The accessory devices 42a-b may comprise mobile or stationary device, such as a printer, a digital projector, a media capturing device, a media rendering device, a storage device, a telephone, a communication device, a wireless accessories, a portable digital assistants (PDAs), a pager, a laptop computer, a mobile computer, a server, a desktop computer, a gaming device, an audio/video player, a digital still/video camera, a positioning device such as a Global Positioning System (GPS) device, a television, a motion sensor, an environmental sensor, a light switch, or a combination thereof, and/or the like.

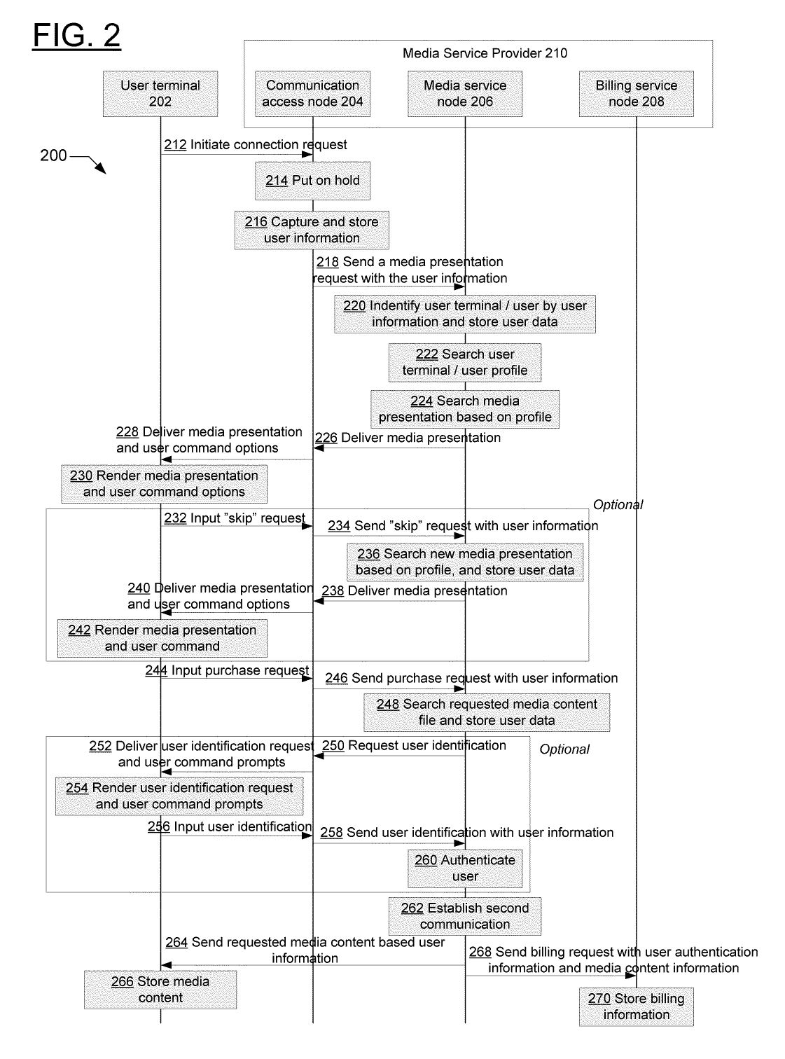

FIG. 2 is a flow diagram illustrating an example method 200 for providing media service according to an example embodiment of the invention. At 212, a first connection between a user terminal and a communication access node may be established or initiated. Further, at 212, a connection request, such as a first connection request, may be established, initiated and/or sent from the user terminal to a callee, callee terminal or service via the communication access node over the first connection. For example, a user terminal 202 may establish, initiate or send the connection request to the callee, callee terminal or service via a communication access node 204 over the first connection. At 214, the first connection or the connection request may be put on hold, or to on-hold mode, if the connection request does not go through to the callee. In an example embodiment, a receiver module in the communication access node 204 may put the first connection or the connection request to on hold, or to on-hold mode, for example if the callee is busy, such as there is an active call, or if the communication access node 204 has set up a waiting or queuing time. In an example embodiment, a caller may call to the communication access node 204 itself. Further, the communication access node 204 may be configured to offer some services itself without connecting other servers or services. In an example embodiment, the first connection or connection request may be a telephonic call such as a cellular or landline phone call. Further, the first connection or connection request may be a telephonic call, such as a Voice over Internet Protocol (VoIP) call, or an instant message connection via the Internet and/or an Internet Protocol (IP) connection.

At 216, user information, such as an address or connection information, from the connection request may be determined. For example, a connection handling module in the communication access node 204 may determine the user information, such the address or the connection information, from the connection request. In an example embodiment, the user information may be the user terminal's 202 address, such as phone number, Mobile Station International Subscriber Directory Number (MSISDN), International Mobile Subscriber Identity (IMSI), international mobile equipment identification (IMEI) code, IP address, email address, Media Access Control (MAC) address, and/or the like. Further, if the first connection link is a telephonic call connection, the communication access node 204 may determine or recognize the caller's phone number. If the first connection link is a VoIP connection the communication access node 204 may determine the caller's email address. Further, at 216, the address or connection information may be stored in the communication access node 204. In an embodiment, the connection handling module in the communication access node 204 may store the address or connection information.

At 218, a first media request, such as a media presentation request, with the determined user information may be sent or delivered to a media service node. In an example embodiment, the communication access node 204 may deliver or send the media presentation request, with the determined user information, such as the address or connection information, to a media service node 206. A receiver module at the media service node 206 may receive the media presentation request and store the media presentation request. The media presentation may be, for example one or more music/audio/video streams or files, location-based content, map files, advertisements, game files, program file, multimedia presentations, image files, text files, messages, web content, broadcasting, multicasting, unicasting, broadcasting service information, such as service and/or channel set-up information, links to content, or a combination thereof, and/or the like. Further, the media presentation may be used to promote, market or advertise to the user or the user terminal 202 some media content that may be downloadable and/or purchasable to the user terminal 202.

At 220, the user terminal and/or the caller may be identified or determined by the user information, such as the address or communication information, by comparing the user information to a customer account information. For example, a search module may be used to identify or determine the user terminal 202 and/or the caller by comparing the address or communication information to the customer account information. The customer account information may be stored in the media service node 206. At 222, if a match is found between the user terminal, such as the user terminal 202, and the customer account information, a profile, such as a user terminal profile and/or user profile, may be selected and/or retrieved. Further, at 222, if a match is found between the caller and the customer account information, the profile, such as the user terminal profile and/or user profile, may be selected and/or retrieved. For example, a search module may be used to search and/or retrieve the profile that is related to the user terminal 202 and/or the caller. At 224, a media presentation and/or an advertisement may be searched and/or selected based on the profile. In an example embodiment, the advertisement may be related to the media presentation. The profile may comprise the user terminal's 202 and/or the caller's preferences relating to media consumption, such as preferred genres, styles, artists, media types, and/or the like. Further, the profile may comprise information relating to previously received media presentations, media content, advertisements, and/or the like. Further, the profile may describe technical capabilities of the user terminal 202, such as memory size, type of one or more media players, size of a display, resolution of a display, available connection types, memory size, and/or the like. The profile may also describe information of the user terminal's 202 and/or the caller's billing information, such as a billing service node's 208 or provider's address, preferred payment method, such as a credit card account or a communication service account, such as a phone bill. Information in the profile may also be updated by the search module 504 after every connection from the user terminal 202 and/or the caller.

At 226, the media presentation and/or the advertisement may be delivered or sent from the media access node to the communication access node with the user information. Further, the delivery may comprise one or more command prompts. In an example embodiment, a delivery module in the media service node 206 may deliver, such as send, stream, multicast, unicast, broadcast, render, and/or the like the media presentation, the advertisement, and/or the one or more command prompts to the communication access node 204. At 228, the media presentation and/or the advertisement may be delivered to the user terminal via the first connection based on the user information. In an example embodiment, the communication access node 204 may deliver, such as send, stream, multicast, unicast, broadcast, render, and/or the like the media presentation, and/or the advertisement to the user terminal 202, based on the user information, via the first connection, which may be still active.

At 228, one or more commands or one or more command prompts may also be set up and/or delivered with or adjacent with the media presentation and/or the advertisement. Additionally, at 228, the one or more commands may be rendered along or during the media presentation and/or the advertisement. For example, a command module in the communication access node 204 may set-up and deliver one or more commands or one or more command prompts with or adjacent with the media presentation. Further, the command module in the communication access node 204 may render the one or more commands along or during the media presentation. The one or more command prompts may be one or more audio prompts, such as “Price 9.99 USD”, “To skip, press 5”, “To place an order, press #”, “To pay by credit card press 1, to pay buy phone bill press 3, now”, “Give user ID by typing, now”, “To skip, say SKIP”, “To place an order, say ORDER”, “To pay by credit card say CREDIT CARD, to pay by a phone bill say PHONE BILL, now”, “Say user ID now”, “Media presentation delivered to user device”, and/or the like. In an example embodiment, the one or more command prompts may be visual prompts, e.g. video, text or pictures prompts displaying such as “Price 9.99 USD”, “To skip, press 5”, “To place an order, press #”, “To skip, say SKIP”, “To place an order, say ORDER”, “To pay by credit card press 1, to pay buy phone bill press 3, now”, “Give user ID by typing, now”, “Media content delivered to user device”, and/or the like.

At 230, the media presentation, the advertisement, the one or more commands, the one or more command prompts, and/or the like may be received, and rendered, e.g. presented, displayed, played, streamed, and/or the like. For example, a receiver module, or a communication module, in the user terminal 202 may receive the media presentation, the advertisement, the one or more commands, and/or the one or more command prompts. Further, a presentation module in the user terminal 202 may render, e.g. present, display, play, stream, and/or the like the media presentation, the advertisement, the one or more commands, the one or more command prompts, and/or the like.

The user, such as the caller, may respond to the one or more command prompts depending on the command options. At 232, the user may input a first user request, such as a skip request or new media presentation request. For example, the user may input and deliver the first user request from the user terminal 202 via the first communication to the receiver module in the communication access node 204. At 234, the first user request may be delivered or sent as such or as a modified request depending on a type of the media service node. Further, at 234, the user information may be added to the first user request. Alternatively, at 234, the user information may be delivered or sent adjacent with the first user request. For example, the command module in the communication access node 204 may deliver or sent the first user request with or adjacent with the user information as such or as a modified request depending on a type of the media service node 206, to the media service node 206.

At 236, a new or next media presentation may be searched and/or selected based on the profile and/or the user information. Also, at 236, the profile may be updated based on action at 236. For example, the search module in the media service node 206 may search and/or select the new or next media presentation based on the profile and the user information, and update the profile. In an example embodiment, at 238-242, the new media presentation may be delivered to the user terminal 202 similarly as at 226-230. The skip request and/or search for the new or next media presentation at 232-242 may be optional.

At 244, in case of the new or next media presentation, or at 230, in case of a first presentation of the media presentation, the user may input a second user request, such as a media content request and/or a media content purchase request. For example, the user of the user terminal 202 may input the second user request via a user command module. Further, the second user request may be delivered via the first connection. In an example embodiment, the second user request may be, for example, the media content request, such as a request for retrieval of an actual media file that may be related to the media presentation that was previously delivered to the user terminal 202. In an example embodiment, the second user request may be, for example, the media content purchase request, such as a request for purchase of the actual media file that may be related to the media presentation that was previously delivered to the user terminal 202. Further, the second user request may comprise metadata information, e.g. a name of the requested media content and/or an identification code (ID) of the requested media content, that identifies the requested media content. The media content may be, for example, one or more music/audio/video file and/or stream, location-based content, map file, game file, multimedia presentation, image file, text file, message, web content, advertisement, broadcasting, multicasting, unicasting, broadcast/multicast/unicast service information, such as service and/or channel set-up information, links to content, and/or the like or a combination thereof.

At 246, the second user request, such as the media content request and/or the media content purchase request, may be delivered as such or as a modified request depending on a type of the media service node. Further, at 246, the second user request may comprise the user information. Additionally, at 246, the second user request may be amended with the user information. In an example embodiment, the command module in the communication access node 204 may deliver the second user request as such or as a modified request depending on a type of the media service node 206, to the media service node 206. Further, the command module in the communication access node 204 may add the user information to the second user request, or send or deliver the user information adjacent with the second user request.

At 248, the media content may be searched and/or selected based on the metadata information and the user information comprised in the second user request. Also the profile may be updated based on action at 248. For example, the search module in the media service node 206 may search and/or select the media content based on the metadata information and the user information. Further, the search module in the media service node 206 may update the profile.

At 250, a user identification request may be sent or delivered. Further, the request may comprise the user information and/or one or more command prompts. In an example embodiment, an authentication module in the media service node 206 may sent or deliver the user identification request comprising e.g. the user information and/or the one or more command prompts to the communication access node 204. The user information in the user identification request may be used to send and/or direct the user identification request to a correct user terminal, for example the user terminal 202.

At 252, the user identification request may be further sent or delivered. In an example embodiment, the command module in the communication access node 206 may sent or deliver the user identification request based on the user information to the user terminal 202 over the first connection. Further, at 252, one or more command prompts may be added to the user identification request, if the one or more command prompts were not already amended to the user identification request at 250. In an example embodiment, the command module in the media access node 206 may add the one or more command prompts to the user identification request.

At 254, the user identification request may be received and rendered, e.g. presented, displayed, played, stream, and/or the like. In an example embodiment, a receiver module or a communication module in the user terminal 202 may receive the user identification request with the one or more command prompts. Further, a presentation module the user terminal 202 may render, e.g. present, display, play, stream, and/or the like user identification request.

At 256, the user may respond to the user identification request. For example, the user may input and deliver the user identification code and/or the password via the first communication to the receiver module in the communication access node 204. At 258, a user response to the user identification request may be delivered as such or as a modified user response based on the type of a media service node. Further, at 258, the user information may be added to the user response. For example, the command module in the communication access node 204 may deliver the user response with the user information to the media service node 206. At 260, the user and/or the user terminal 202 may be authenticated by the received user respond to the user identification request. In an example embodiment, the authentication module in the media access node may authenticate the user and/or the user terminal 202 and allow delivering and/or access to the requested media content. The request for the user identification at 232-242 may be optional.

At 262, a second connection may be initiated or established based on the user information. In an example embodiment, the delivery module in the media service node 206 may initiate or establish the second connection to the user terminal 202. Further, the second connection, such as a second link, second network or second access, may be initiated or established based on the user information, such as the address or the connection information of the user terminal 202, that was determined over the first connection, at 216. Further, at 262, a second connection request may be initiated, established or sent at the media service node 206. For example, the delivery module may be configured to initiate, establish or send the second connection request to the user terminal 202 for setting up the second connection for delivering the media content from the media service node 206.

At 264, the media content and/or the advertisement may be delivered to the user terminal over the second connection. In an example embodiment, the media content and/or the advertisement may be delivered by the delivery module in the media service node 204 to the user terminal 202 over the second connection, e.g. over the second communication link, second network, or second access. In an example embodiment, the second connection may be e.g. a message connection, such as the SMS or MMS connection, the audio or video call, the instant message connection, and or the like. The media content and/or an advertisement may be delivered, for example, as a message, a part of the message, a file comprised in the message, a web link to the media presentation, stream, broadcast, multicast, unicast, and/or the like, or a combination thereof.

At 266, the received media content and/or the advertisement may be stored and/or rendered. Additionally, at 266, an indication of reception of the media content and/or the advertisement may be given. The indication may be e.g. audio, light, haptic, text notice, message, and/or the like, or a combination thereof. For example, the presentation module in the user terminal 202 may render the indication, the media content and/or the advertisement. In an example embodiment, the media content and/or the advertisement may be received, for example, as a message, a part of the message, a file comprised in the message, a web link to the media presentation, stream, broadcast, multicast, unicast, and/or the like, or a combination thereof. Further, a memory module in the user terminal 202 may store the received media content and/or the additional advertisement.

At 268, a billing request with billing information, e.g. user selected preferred billing method information, user authentication information, the user information, the selected media content information, and/or the like may be delivered to a billing service node. Further, at 268, the billing request may be stored, the profile may be updated, and actions for actual billing may be done. In an example embodiment, the media service node 206 may deliver, provide or send the billing request with the billing information to a billing service node 208. Further, the media service node 206 may instruct the billing service node 208 to bill the media content based on the user information in a user's communication service account that may be related to the user terminal 202 and/or the user. In an example embodiment, the user's communication service account may be, for example, a phone bill, network connection bill, Internet access bill, data connection bill, and/or the like, or a combination thereof. In an example embodiment, the billing service node 208 may be, such as a communication service provider, a telecommunication operator, Internet access operator, Internet service provider, media service provider, music service provider, video service provider, map service provider, and/or the like, or a combination thereof. Further, the billing service node 208 may be the communication access node 204, the media service node 206, or the media service provider 210.

In an example embodiment, the one or more operations, modules, programs, actions, systems, methods, as described relating to the communication access node 204, the media service node 206, and/or the billing service node 208 may be combined to one service node, such as the media service provider 210. In an example embodiment, the media service provider 210 may be, such as an electronic device, apparatus, server, server system, service provider, and/or the like, or a combination thereof. For example, the communication access node 204 and the media service node 206 may be in the same service node. Further, the communication access node 204 may receive and store a media presentation and/or media content already in advance of the connection request, at 212, from the media service node 206, and deliver and/or provide the media presentation and/or the media content without communicating with the media service node 206.

In an example embodiment, the nodes 202-210, actions 212-270, or a combination thereof, as described in the flow diagram 200 may be implemented by various techniques, such as one or more hardware or firmware, one or more CPUs, one or more computer program instructions, one or more application program interfaces (APIs), and/or the like, or a combination thereof. In this regard, the one or more computer program instructions and/or one or more APIs which embody the actions 212-270 may be stored by one or more memory devices, units, modules, and/or the like of the one or more nodes 202-210. It should also be further understood, that some embodiments of the invention, the one or more nodes or actions as described in the flow diagram 200 may not be needed to provide the media service to the user terminal 202. Further, the actions 212-270 between the nodes may be communicated also in a different order to provide the media service to the user terminal 202.

In an example embodiment, the caller may initiate a phone call from his cellular phone, such as the user terminal 202, to a number +1 234 567 8989 that may define a receiver phone in a Company XYZ. The call may be received at the communication access node 204, such as a PBX, that puts the call on-hold because the receiver phone is busy. Instead of playing a monotonous audio signal the PBX may offer to the caller more meaningful music presentation via the phone call. Therefore, the PBX first determines a phone number of the cellular phone, and checks if this phone number already has an account and/or a profile in a system. If the account or profile is found, the PBX uses the account or profile information to select an appropriate song from a database. This song may be then played back via the phone call to the cellular phone. Additionally, one or more command prompts may be presented on the phone call. If the caller likes the song he may press, for example, a # button to select and establish the media content request, such as a purchase request, for the song. After the PBX has received the purchase request, it sends a selected song file to the cellular phone, according to the determined phone number, over a message communication, such as a MMS communication. If the PBX does not have the user account and/or profile for the cellular phone, and/or a databases for songs, the PBX may send a media presentation request with the determined phone number, to a music service provider, such as a media service node 206, that selects an appropriate song from a database and delivers the song to the PBX for further delivery to the user terminal 202. Additionally, the PBX may send the purchase request to the media service provider that further delivers the requested song file back to the PBX for further delivery to the user terminal 202.

In an example embodiment, the caller may initiate a phone call from his cellular phone, such as the user terminal 202, to a number +1 234 567 8989 that may define a receiver phone in a Company XYZ. The call may be received at the communication access node 204, such a PBX, that puts the call on-hold because the receiver phone is busy. During a waiting period the PBX may play a message and one or more command prompts that offer the caller a map of the Company XYZ's location. If the caller response is positive to the message, the PBX first determines a phone number of the cellular phone and then sends a map file to the cellular phone, according to the determined phone number, over a message communication, such as a MMS communication.

In an example embodiment, the caller may initiate a VoIP video call from his VoIP terminal, such as the user terminal 202, to a number +1 234 567 8989 that may define a receiver video phone in a Company XYZ. The call may be received at the communication access node 204, such as a call server, that puts the call on-hold because the receiver video phone is busy. Instead of playing a monotonous audio and/or video signal the call server may offer to the caller a video presentation via the VoIP video call. Therefore, the call server first determines an address of the VoIP terminal, and check if this address already has an account and/or a profile in a system. If the account or profiles is found, the call server uses this information to select an appropriate video from a database. This video is then played back via the VoIP video call to the caller's VoIP terminal. Additionally, one or more command prompts may be presented during the VoIP video call. If the caller likes the video he may say, for example, “BUY” to select and establish a purchase request for a video file. After the call server has received the purchase request, it sends to the VoIP terminal a message, such as a SMS message, comprising a web link to the requested video file.

In an example embodiment, the caller may initiate a VoIP call from his VoIP terminal, such as the user terminal 202, to an address “mahon@home.net” that is related to a receiver phone in a Company XYZ. The VoIP call may be received first at the communication access node 202, such as a VoIP call service provider, that finds out that the receiving address “mahon@home.net” is busy. The VoIP call service provider may now offer to the VoIP terminal a video presentation via the VoIP call. The video is played back during the VoIP call to the caller's VoIP phone. Additionally, one or more command prompts may be presented during the video playback. If the caller likes the video he may say, for example, “BUY” to select and establish a purchase request for a video file. After the VoIP call service provider has received the purchase request, it captures the VoIP terminal's address, such as an email address, from the VoIP call, and sends to the captured address a message, such as an instant message comprising a web link to the requested video content file.

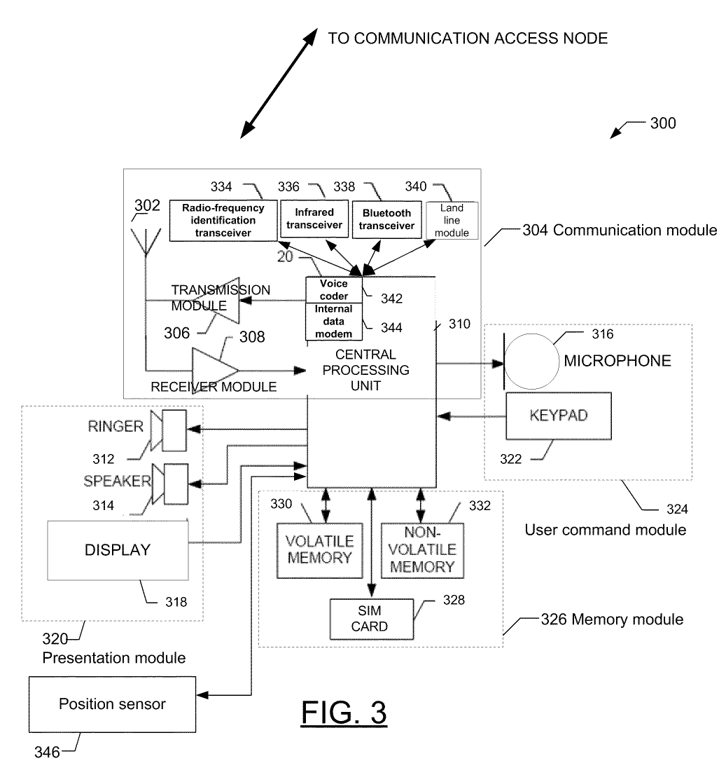

FIG. 3 is a block diagram depicting a user terminal 300 according to an example embodiment of the invention. In an example embodiment, the user terminal 300, such as user terminal 202 of FIG. 2 and/or user terminals 12a-d of FIG. 1, may receive and request the media service. It should be understood that the user terminal 300 illustrated and described is merely illustrative of one example of a fixed or mobile electronic device, which may benefit from example embodiments of the invention and, therefore, should not be taken to limit the scope of the invention. In an example embodiment, the user terminal 300 may be, for example a landline phone, cellular telephone, mobile communication device, portable digital assistant (PDA), pager, mobile computer, laptop computer, desktop computer, Internet browser device, gaming device, audio/video player, digital still/video camera, video phone, positioning device (such as a Global Positioning System (GPS) device), television, radio broadcast receiver, and/or the like, or a combination thereof. The user terminal 300 may be capable, for example, for telephonic calls, data calls, video phone calls, text messaging, multimedia messaging, email messaging, instant messaging, and sending, receiving, delivering, creating, rendering, and/or storing etc. various kind of media presentations and media content.

In an example embodiment, the user terminal 300 may comprise one or more communication modules 304, central processing units (CPU) 310, presentation modules 320, user command modules 324, memory modules 326, position sensors 346, user interfaces comprising a presentation modules 320, user command modules 324, and/or the like, that may communicate with each other. The communication module 304 may comprise one or more transmission modules 306, such as wireless transmitters, one or more receiver modules 308, such as wireless receivers, and/or one or more transceiver modules, such as one or more wireless transceivers. The communication module 304 may also comprise a landline communication module 340 that may further comprise a transmission module and receiver module for telephonic communication, data communication, and internet communication, for example, over the PSTN. The CPU 310 may be a digital signal processor, microprocessor, analog-to-digital converter, digital-to-analog converter, and/or the like. The one or more CPUs 310 may be in communication with the one or more memory modules 326, that may comprise one or more programming codes, such as for example applications, logics, APIs, and/or the like. The one or more programming codes may control and execute operations of the user terminal 300 by controlling the transmission module, 306, the receiver module 308, the presentation module 320, the user command module 324, and the one or more memory modules 326, the position sensor 346, to provide the media service to the user terminal 300. Further, the CPU 310 may control, transmit and/or receive one or more signals to/from the communication module 304. The CPU 310 may also comprise, for example, a circuitry configured to implement audio, video and/or logic operations of the user terminal 300. The CPU 310 may also comprise an internal voice coder (VC) 342, an internal data modem (DM) 344, and/or the like.

In an example embodiment, the one or more signals may comprise signaling information in accordance with one or more communication interface standards, such as a cellular communication system, short range radio communication system, and/or the like. Further, the one or more signals may comprise speech data, user generated data, user requested data, data files, media files, program files, packet data, IP data, broadcasting, multicasting, unicasting, and/or the like. The user terminal 300 may be also configured to operate, for example, with one or more air interface standards, communication protocols, modulation types, access types, and/or the like. In an example embodiment, the user terminal 300 may be configured to operate in accordance with various communication protocols, such as for example, Wi-Fi, WLAN, UWB, WiMAX, Wibree, IG, Narrowband Advanced Mobile Phone System (NAMPS), Total Access Communication System (TACS), 2G, IS-136, TDMA, GSM, IS-95, CDMA, CDMA2000, 2.5G, GPRS, EDGE, 3G, HSDPA, UMTS, WCDMA, 3.9G, 4G, LTE, and/or the like, or a combination thereof.

In an example embodiment, the CPU 310 may be configured to operate the communication module 304 with a connectivity program, such as an Internet browser. For example, the Internet browser may allow the user terminal 300 to transmit and receive IP data packets, such as one or more media presentations or media contents, music/audio/video files and streams, location-based content, map files, game files, program files, multimedia presentations, image files, text files, messages, broadcasting, multicasting, unicasting, broadcast/multicast/unicast service information, such as e.g. service and/or channel set-up information, links to content, and/or the like, or a combination thereof, by using TCP/IP protocol. In an example embodiment, the CPU 310 may be configured to operate the communication module 304 with another connectivity program, such as a Voice over Internet Protocol (VOIP) program. For example, the VoIP program may allow the user terminal 300 to transmit and receive IP data packets, such as audio and/or video phone calls using the TCP/IP protocol. In an example embodiment, the CPU 310 may be also configured to operate the communication module 304 with another connectivity program, such as an instant message program. For example, the instant message program may allow the user terminal 300 to transmit and receive IP data packets, such as such as text and graphical content, using the TCP/IP protocol.

In an example embodiment, the user interface may comprise one or more programs, APIs, and/or the like allowing the user terminal 300 to receive and render one or more commands prompts and respond to the one or more command prompts. In an example embodiment, the presentation module 320 may comprise an earphone, a speaker 314, a ringer 312, a display 318, and/or the like, which may communicate with the CPU 310. Further, the user command module 324 may comprise a microphone 316, a keypad 322, a touch display, a joystick, other input device, and/or the like, which may communicate with the CPU 310. In an example embodiment, the keypad 322 or the touch display may comprise numeric 0-9 keys and related keys # and *, QWERTY keyboard, and/or the like for operating the user terminal 300. Further, the user command module 324 may comprise device and programs, such as a voice recognition system, allowing the user terminal to receive one or more voice commands from a user. In an example embodiment, the user terminal 300 may comprise a battery and/or an alternating current/direct current (AC/DC) power source for powering one or more circuits, antennas, processors, modules, memories, mechanical devices, such as a vibrator, and/or the like.

In an example embodiment, the communication module 304, such as a transmission module 306, in communication with one or more antennas 302, may be configured to deliver or send a user input, such as a voice command, received in the user input interface or the user command module 324 over a network connection to another apparatus in the network. In example embodiment, the communication module 304 may comprise a Radio-Frequency Identification (RFID) transceiver 334, infrared (IR) transceiver 336, Bluetooth transceiver 338, and/or the like. For example, the communication module 304 may be configured to transmit data to and/or receiving data from other electronic devices within proximity of the user terminal 300. In an example embodiment, the communication module 304 may comprise a broadcast receiver module 308 for receiving analog and/or digital radio and/or television broadcasting, multicasting or unicasting over multiple standards and protocols, for example, Digital Video Broadcasting-Handheld (DVB-H), Digital Video Broadcasting-Satellite services to Handhelds (DVB-SH), DVB-Internet Protocol Datacasting (DVB-IPDC), MediaFLO, Digital Multimedia Broadcasting (DMB), Multimedia Broadcast Multicast Service (MBMS), Digital Audio Broadcasting (DAB), and/or the like, or a combination thereof.

In an example embodiment, the memory module 326, which may comprise a volatile memory 330, non-volatile memory 332, subscriber identity module (SIM) 328, removable user identity module (R-UIM), and/or the like. Further, the user terminal 300 may comprise one or more removable memory modules, fixed memory modules, and/or the like. The volatile memory 330 may be such as a volatile Random Access Memory (RAM), which may comprise a cache area for temporary storage of data. The non-volatile memory 332 may be embedded, removable, or a combination thereof. The non-volatile memory may comprise an Electrically Erasable Programmable Read-Only Memory (EEPROM), flash memory, and/or the like. In an example embodiment, the memory module 326 may store one or more software programs, instructions, pieces of information, data, logics, APIs and/or the like which may be used by to perform techniques or applications of the user terminal 300, and to render media service in the user terminal 300.

In an example embodiment, the memory module 326 may comprise an identifier or an address of the user terminal, such as the IMEI code, IMSI, a phone number, MSISDN, IP address, MAC address, Internet address, and/or the like, that may uniquely identify the user terminal 300. Further, the memory module may comprise media files, such as music files, audio files, video files, images, maps, documents, multimedia presentations, program files, and/or the like.

In an example embodiment, the user one or more position sensors 346 may be configured to determine a location of user terminal 300, for example, to identify latitude and longitude coordinates of the user terminal 300 or a position relative to a reference point, such as a destination or a starting point. The position sensor 346 may comprise, for example, a global positioning system (GPS) sensor, an Assisted Global Positioning System (Assisted-GPS) sensor, and/or the like. In an example embodiment, the position sensor 346 may also comprise a pedometer, inertial sensor and/or the like. Further, the position sensor 346 may be configured to determine the location of the user terminal 300 based upon signal triangulation or other mechanisms. Further, the position sensor 346 may be used to determine cell identification (ID) information of a call, which the user terminal 300 is in communication with. In conjunction with other location information the cell ID information may be used to more accurately determine the location of the user terminal 300. In an example embodiment, the location of the user terminal 300 may be delivered to a service provider, such as the media service node 206 in FIG. 2, to determine the media service based on the location of the user terminal 300. Further, the position sensor 346 may communicate the location information to the memory module 326 or to another memory device to be stored as position or location history information.

In an example embodiment, the transmission module 306 may be a connection application, such as for example a program, logic, API, and/or the like that may be stored in the one or memory modules 326. The connection application may be controlled or executed by the one or more CPUs 310. Further, the transmission module 306 may be a transmitter device comprising one or more processing units and memory units with application, program, logic, and/or API information. The transmission module 306 may be configured to establish or set up a network connections and a connection request to other devices. The connection request may be for example a telephonic call, such as a cellular phone call or a landline call, a VoIP call or an instant message request. The network connections or connection requests may be established to the media service node 206 and/or to the communication access node 204.

In an example embodiment, the receiver module 308 may be a connection application, such as a program, logic, API, and/or the like that may be stored in the one or more memory modules 326. The connection application may be controlled or executed by the one or more CPUs 310. Further, the receiver module 308 may be a receiver device comprising one or more processing units and memory units with application, program, logic, and/or API information. The receiver module 308 may be connected to a communication network, for example the media service provider 206 and/or to the communication access node 204 of FIG. 2, and used to receive for example media presentations, media content, media service, messages, instant messaging, telephonic calls, video phone calls, broadcasting, multicasting, unicasting, command prompts, and/or the like.

In an example embodiment, the presentation module 320 may be a rendering application, such as for example a program, logic, API, and/or the like that may be stored in the one or memory modules 326. The connection application be controlled or executed by the one or more CPUs 310. Further, the presentation module 320 may be a rendering device comprising one or more processing units and memory units with application, program, logic, and/or API information. The presentation module 320 may be configured to, for example, render the media presentations, media content, media service, messages, instant messaging, telephonic calls, video phone calls, broadcasting, multicasting, unicasting and/or one or more command prompts that may be received, for example, from the media service node 206 and/or the communication access node 204.

In an example embodiment, the user command module 324 may be a command application, such as for example program, logic, API, and/or the like that may be stored in the one or memory modules 326. The connection application may be controlled or executed by the one or more CPUs 310. Further, the user command module 324 may be a command device comprising one or more processing units and memory units with application, program, logic, and/or API information. The user command module 324 may be used to render one or more command prompts, receive user input and/or to deliver them to other devices, such as the media service node 206 and/or to the communication access node 204. Additionally, the user command module 324 may also comprise a voice recognition application.

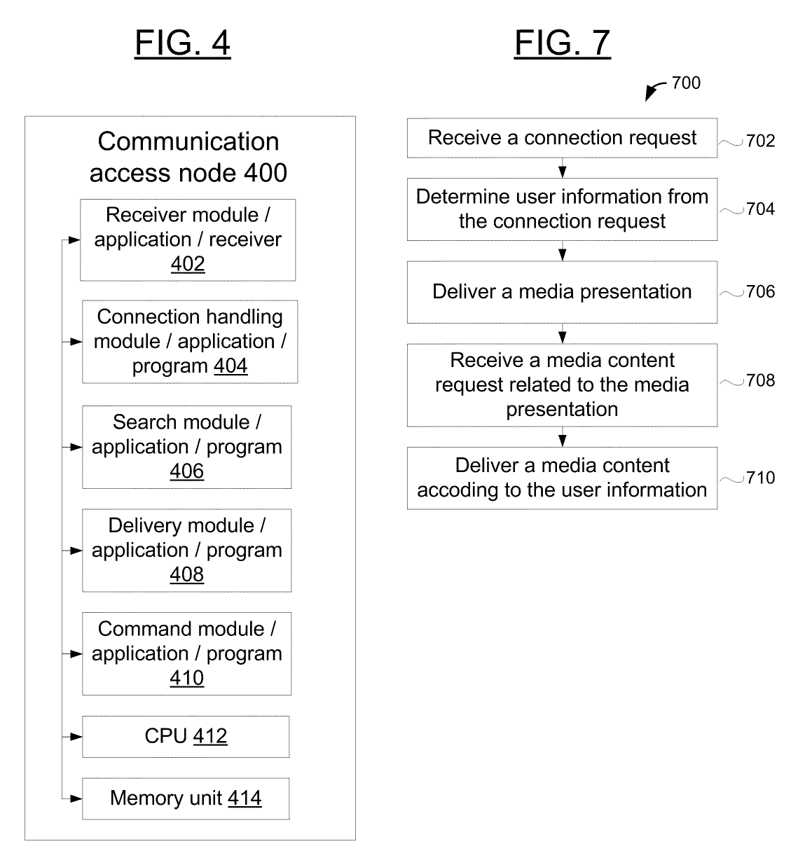

FIG. 4 is a block diagram depicting a communication access node 400 according to an example embodiment of the invention. The communication access node 400, such as communication access node 204 of FIG. 2 and/or communication access node 36 of FIG. 1, may provide the media service to a user device, according to an example embodiment. Further, the communication access node 400 may be, for example, a network server, private branch exchange (PBX), hosted PBX system, mobile PBX, Internet protocol PBX, telephone system, call center, server computer, service provider, computing system, origin server, BS, MSC, gateway, SGSN, GGSN, network access point, and/or the like, or a combination thereof. The communication access node 400 is merely illustrative of one type electronic device or apparatus that may benefit from one or more example embodiments of the present invention and, therefore, should not be taken to limit the scope of the present invention.

In an example embodiment, the communication access node 400 may comprise a receiver module 402, connection handling module 404, search module 406, delivery module 408, command module 410, one or more processing units (CPU) 412, one or more memory units 414, and/or the like, that may be in communication with each other. Further, the one or more CPUs 412 may be in communication with the one or more memories units 414, that may comprise one or more programming codes. In an example embodiment, the one or more CPUs 412 may be configured to control and execute operations of the communication access node 400 by controlling the receiver module 402, the connection handling module 404, the search module 406, the delivery module 408, the command module 410, and the one or more memories 414. Further, the programming code may comprise, for example, program logic, application, API, and/or the like.

In an example embodiment, the receiver module 402 may be a receiver application, such as for example a program, logic, API, and/or the like, that may be stored in the one or memory units 414. The receiver application may be controlled or executed by the one or more CPUs 412. Further, the receiver module 402 may be a receiver device comprising one or more processing units and memory units with application, program, logic, and/or API information. The receiver module 402 may be configured to receive a connection request from a user terminal, such as user terminal 300 of FIG. 3, user terminal 202 of FIG. 2 and/or user terminals 12a-d of FIG. 1, via a network. The connection request may telephonic call, such as a cellular phone call or a landline call, a VoIP call or an instant message request.

In an example embodiment, the connection handling module 404 may be a connection application, such as for example a program, logic, API, and/or the like that may be stored in the one or memory units 414. The connection application may be controlled or executed by the one or more CPUs 412. Further, the connection handling module 404 may be a connection handling device comprising one or more processing units and memory units with application, program, logic, and/or API information. The connection handling module 404, that may be in communication with the receiver module 402, and may be configured to determine an address from the connection request. In an example embodiment, the address may be a phone number, MSISDN, IP address, internet address, IMSI, IMEI code, MAC address, and/or the like.

In an example embodiment, the search module 406 may be a search application, such as for example a program, logic, API, and/or the like that may be stored in the one or memory units 414. The search application may be controlled or executed by the one or more CPUs 412. Further, the search module 404 may be a search device comprising one or more processing units and memory units with application, program, logic, and/or API information. The search module 406 may be configured to search and find, for example, service account information, user information, user profile, media presentation media content, and/or the like in the communication access node 400.

In an example embodiment, the delivery module 408 may be a delivery application, such as for example a program, logic, API, and/or the like that may be stored in the one or memory units 414 The delivery application may be controlled or executed by the one or more CPUs 412. Further, the delivery module 404 may be a delivery device comprising one or more processing units and memory units with application, program, logic, and/or API information. The delivery module 408 may be configured to deliver the media service, messages, the media presentation, the media content, and/or the like to one or more other devices.

In an example embodiment, the command module 410 may be a command application, such as for example a program, logic, API, and/or the like that may be stored in the one or memory units 414. The command application may be controlled or executed by the one or more CPUs 412. Further, the command module 410 may be a command device comprising one or more processing units and memory units with application, program, logic, and/or API information. The command module 410 may be used to set up, determine, deliver, receive, recognize, and/or the like one or more key pad commands and/or voice commands. The command module 410 may comprise a speech recognition application, program, logic, and/or API. The command module 410 may be optional to the system.

In an example embodiment, the receiver module 402, connection handling module 404, and delivery module 408 may form a communication module. The communication module may be a command application, such as for example a program, logic, API, and/or the like that may be stored in the one or memory units 414. The communication module may be controlled or executed by the one or more CPUs 412. Further, the communication module may be a delivery device comprising one or more processing units and memory units with application, program, logic, and/or API information.

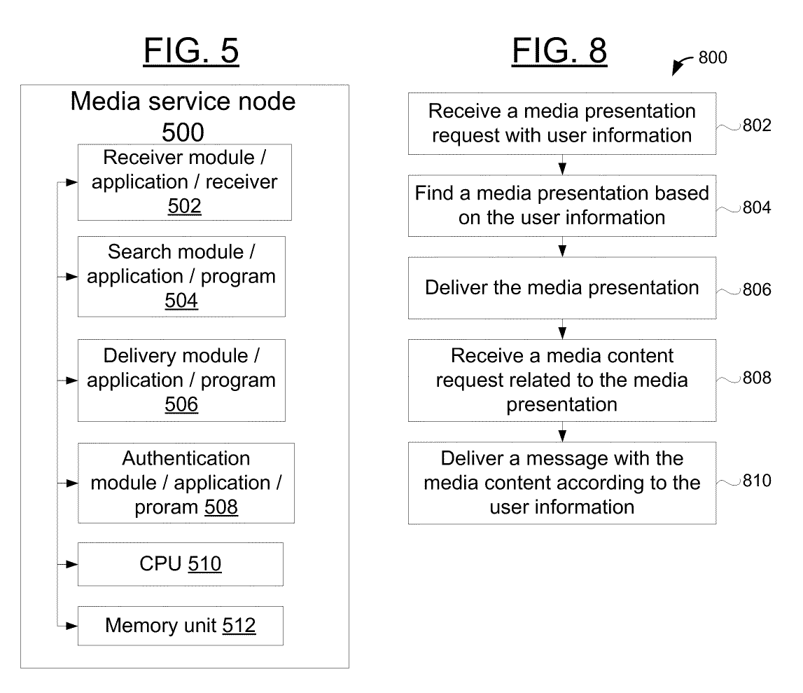

FIG. 5 is a block diagram depicting a media service node 500 according to an example embodiment of the invention. The media service node 500, such as media service node 206 of FIG. 2 and/or media service node 38 of FIG. 1, may provide the media service to a user device according to an example embodiment. Further, the media service node 500 may be, for example, a server computer, service provider, computing system, origin server, and/or the like, or a combination thereof. The media service node 500 as illustrated and hereinafter described is merely illustrative of one type electronic device or apparatus that may benefit from one or more example embodiments of the present invention and, therefore, should not be taken to limit the scope of the present invention.

In an example embodiment, the media service node 500 may comprise a receiver module 502, search module 504, delivery module 506, authentication module 508, one or more central processing units (CPUs) 510, one or more memory units 512, and/or the like, that may communicate with each other. Further, the one or more CPUs 510 may communicate with the one or more memory units 512, that may comprise one or more programming codes, application programming interfaces (API), and/or the like. In an example embodiment, the one or more CPUs 510 may control and execute operations of the media service node 500 by controlling the receiver module 502, the search module 504, the delivery module 506, the authentication module 508, and the one or more memory units 512.

In an example embodiment, the receiver module 502 may be a receiver application, such as for example a program, logic, API, and/or the like that may be stored in the one or memory units 512. The receiver application may be controlled or executed by the one or more CPUs 510. Further, the receiver module 502 may be a receiver device comprising one or more processing units and memory units with application, program, logic, and/or API information. In an example embodiment, the receiver module 502 may be configured to receive request for media presentation and/or media content, for example from a communication access node. Further, the receiver module 502 may be configured to deliver the request for media presentation and/or media content to the search module 504.

In an example embodiment, the search module 504 may be a search application, such as for example a program, logic, API, and/or the like that may be stored in the one or memory units 512. The search application may be controlled or executed by the one or more CPUs 510. Further, the search module 502 may be a search device comprising one or more processing units and memory units with application, program, logic, and/or API information. In an example embodiment, the search module 502 may be configured to search and find service account information, user information, user profiles, media presentations and media content in the one or more memory units 512 based on the request for the media presentation and/or media content received, for example, from the receiver module 502.

In an example embodiment, the delivery module 506 may be a delivery application, such as for example a program, logic, API, and/or the like that may be stored in the one or memory units 512. The delivery application may be controlled or executed by the one or more CPUs 510. Further, the delivery module 506 may be a delivery device comprising one or more processing units and memory units with application, program, logic, and/or API information. In an example embodiment, the delivery module 506 may be configured to deliver the service account information, the user information, the user profiles, the media presentations the media content, and/or the like to one or more other devices.

In an example embodiment, the receiver module 504, search module 504, and delivery module 506 may be formed as a communication module. The communication module may be a command application, such as a program, logic, API, and/or the like that may be stored in the one or memory units 512. The communication module may be controlled or executed by the one or more CPUs 510. Further, the communication module may be a delivery device comprising one or more processing units and memory units with application, program, logic, and/or API information.

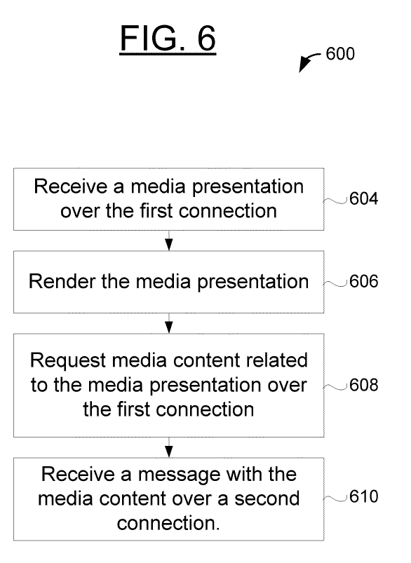

FIG. 6 is a flow diagram illustrating an example method 600 for providing media service according to an example embodiment of the invention. At 604, a media presentation may be received over a first connection in a user terminal. In an example embodiment, the media presentation may be received in a user terminal, such as user terminal 300 of FIG. 3, from a communication access node. Further, a receiver module, such as receiver module 308 of FIG. 3, may be configured to receive the media presentation over the first connection. At 604, the first connection to the communication access node may be initiated or established. In an example embodiment, the user terminal may be configured to initiate or establish the first connection to the communication access node. Further, a transmission module, such as the transmission module 306 of FIG. 3, may be configured to initiate or establish the first connection to the communication access node.

In an example embodiment, the first connection may be, for example, a telephonic call, instant messaging connection, and/or the like. At 606, the media presentation may be rendered in the user terminal. For example, a presentation module, such as presentation module 320 of FIG. 3, may be configured to render the media presentation. At 608, media content may be requested, wherein the media content relates to the media presentation that was received over the first connection. For example, a media content request related to the media presentation may be initiated, established, and/or send over the first connection to the communication access node. For example, a transmission module, such as transmission module 306 of FIG. 3, may be configured to send the media content request related to the media presentation over the first connection to the communication access node. Further, a user input may be received for the media content. For example, the user terminal may further comprise a user command module, such as the user command module 324 of FIG. 3. The user command module may be configured to receive the user input, for example the media content request, for the media presentation. At 610, a media content may be received over a second connection. For example, the receiver module may be configured to receive the media content, which may be related to the media content request, over the second connection from a media service node. Further, the second connection may be initiated or established at the user terminal. For example, the receiver module may be configured to initiate, establish or receive a second connection request at the user terminal for receiving the media content from the media service node.

In an example embodiment of the invention, the first connection may be a telephonic call. In an example embodiment, of the invention, the first connection may be an instant message connection.

In an example embodiment of the invention, the media presentation may be a music presentation, video presentation, audio presentation, text presentation, media broadcasting, media multicasting, media unicasting, media streaming, multimedia presentation, map, advertisement, a combination thereof, and/or the like.

In an example embodiment of the invention, requesting the media content further comprises sending a media content request over the first communication. The media content request may be at least one of the following: an audio command, key pad command, a combination thereof, and/or the like.

In an example embodiment of the invention, the media content may be a music file, video file, audio file, map file, game file, text presentation, broadcast channel information, advertisement, link to the media content, a program file, a combination thereof, and/or the like.

In an example embodiment of if the invention, the media content may be received in a message. For example, the message may be received over the second connection from the media service node. Further, the receiver module may be further configured to receive the media content may be received in the message over the second connection from the media service node.

In an example embodiment of the invention, the second connection may be a message connection. In an example embodiment of the invention, a user input may be received for the media presentation. For example, the user terminal may further comprise a user command module that may be configured to receive the user input for the media presentation

FIG. 7 is a flow diagram illustrating an example method 700 for providing media service according to an example embodiment of the invention. At 702, a connection request may be received from a user terminal. For example, in a communication access node, such as the communication access node 400 of FIG. 4, a receiver module, such as receiver module 402 of FIG. 4, may be configured to receive the connection request over a first connection from the user terminal. At 704, user information, such as connection information, an address, and/or the like, of the user terminal may be determined from the connection request. In an example embodiment, the user information, such as connection information, an address, and/or the like may be also determined from the first connection. In an example embodiment, a connection handling module, such as connection handling module 404 of FIG. 4, may be configured to determine the user information from the connection request over the first connection. At 706, a media presentation may be delivered to the user terminal. In an example embodiment, a delivery module, such as the delivery module 408 of FIG. 4, may be configured to deliver the media presentation to the user terminal over the first connection. At 708, a media content request related to the media presentation may be received. In an example embodiment, the receiver module may be configured to receive the media content request over the first connection. At 710, the media content may be delivered to the user terminal. In an example embodiment, the media content may be delivered using or according to the user information that was determined at 704. In an example embodiment, the delivery module may be configured to deliver the media content to the user terminal according to the user information over a second connection.

In an example embodiment of the invention, the user information may be connection information, phone number, email address, Internet protocol address, a combination thereof, and/or the like. Further, in an example embodiment of the invention, a user may be identified based on the user information.

In an example embodiment of the invention, the connection request may be received over a telephonic call, instant messaging, and/or the like from the user terminal, and a message may be delivered over a message connection, an instant message connection, a combination thereof, and/or the like to the user terminal. For example, the receiver module 402 may be further configured to receive the connection request over the telephonic call, instant messaging, and/or the like from the user terminal, and to deliver the message over the message connection, the instant message connection, a combination thereof, and/or the like to the user terminal.

In an example embodiment of the invention, the media presentation related to the user information, such as the connection information or address, may be searched and/or selected. Further, the communication access node may comprise a search module, such as search module 406 of the FIG. 4, which may be configured to search and/or select the media presentation. Additionally, a profile based on the user information may be found, and the media presentation may be searched and/or selected based on the profile. The search module 406 may be additionally configured to search and/or select the profile based on the user information and to search and/or select the media presentation. Further, the media presentation request with the user information may be delivered to the media service node, and the media presentation may be received from the media service node. The search module may be further configured to deliver the media presentation request with the user information, such as the address, to a media service node, and to receive the media presentation from the media service node.

In an example embodiment, the media content may be delivered in a message. For example, the delivery module may be configured to deliver the media content in the message.

In an example embodiment of the invention, the media presentation may be rendered, such as displayed, played, and/or the like. For example, the delivery module 408 may be further configured to render the media presentation to the user terminal.

In an example embodiment of the invention, one or more audio commands, one or more key pad commands, and/or the like may be set up and delivered. In an embodiment, the communication access node may comprise a command module. The command module may be further configured to set up and deliver the one or more audio and/or one or more key pad commands. The command module may be further configured to receive and decipher the media content request with the audio command and/or the key pad command, and/or the like. In an embodiment, the media content request may be received over or with one or more audio commands, one or more key pad commands, and/or the like.

In an example embodiment of the invention, the media content request may be delivered to the media service node with instructions to send the media content according to the user information, such as the connection information, address, and/or the like to the user terminal. The delivery module may be further configured to deliver the media content request to the media service node with instructions to send the media content according to the user information to the user terminal.

In an example embodiment of the invention, the user and/or user terminal information may be determined from the connection request in the first connection, the media presentation may be delivered in the first connection, the media content request related to the media presentation may be received in the first connection, and the media content may be delivered to the user terminal in the second connection according to the user information. The connection handling module may be further configured to determine the user and/or user terminal information from the connection request in the first connection, the delivery module may be further configured to deliver the media presentation in the first connection, the receiver module may be further configured to receive the media content request related to the media presentation in the first connection, and the delivery module may be further configured to deliver the media content in a second connection according to the user information. Further, the first connection may be telephonic call or instant messaging connection, and the second connection may be a message connection.

In an example embodiment of the invention, the media presentation may be a music presentation, video presentation, audio presentation, text presentation, media broadcasting, media multicasting, media unicasting, media streaming, multimedia presentation, map, advertisement, and/or the like, or a combination thereof.

In an example embodiment of the invention, the media content may be a music file, video file, audio file, map file, game file, program file, text presentation, broadcast channel information, advertisement, a link to the media content, and/or the like, or a combination thereof.

In an example embodiment of the invention, the communication request may be put on-hold mode. The connection handling module may be further configured to put the communication request on-hold mode.

FIG. 8 is a flow diagram illustrating an example method 800 for providing media service according to an example embodiment of the invention. At 802, a media presentation request is received with user information from a communication access node. In an example embodiment, a media service node, such as media service node 500 of FIG. 5, a receiver module, such as receiver module 502 of FIG. 5, may be configured to receive the media presentation request from a communication access node. At 804, a media presentation may be searched and/or selected based on the user information. In an example embodiment, a search module, such as search module 504 of FIG. 5, may be configured to search and/or select the media presentation based on the user information. At 806, the media presentation may be delivered to the communication access node. In an example embodiment, a delivery module, such as delivery module 506 of FIG. 5, may be configured to deliver the media presentation the communication access node. At 808, a media content request related to the media presentation may be received. In an example embodiment, the receiver module may be further configured to receive the media content request related to the media presentation from the communication access node. At 810, the media content may be delivered according to the user information to a user terminal, such as user terminal 300 of FIG. 3 or the like. In an example embodiment, the delivery module may be further configured to deliver the media content according to the user information to the user terminal.

In an example embodiment of the invention, the user information may be such as connection information, phone number, email address, internet protocol address, and/or the like. In an example embodiment, the media content may be delivered according to or using the user information, for example to the phone number, email address, and/or internet protocol address. The delivery module may be further configured to deliver the media content according to or using the user information, for example to the phone number, internet address, and/or internet protocol address.

In an example embodiment, a user and/or the user terminal may be defined based on the user information. For example, the search module may be further configured to define the user and/or the user terminal based on the user information.

In an example embodiment of the invention, a profile may be searched and/or selected based on the user information and the media presentation may be searched and/or selected based on the profile. The search module may be further configured to search and/or select the profile based on the user information and to search and/or select the media presentation based on the profile.

In an example embodiment of the invention, the media presentation may be for example a music presentation, video presentation, audio presentation, text presentation, media broadcasting, media multicasting, media unicasting, media streaming, multimedia presentation, map, advertisement, a combination thereof, and/or the like.

In an example embodiment of the invention, the media content may be for example a music file, video file, audio file, map file, game file, program file, text presentation, broadcast channel information, advertisement, a link to the media content, a combination thereof, and/or the like.

In an example embodiment of the invention, the media content may be delivered in a message using or according to the user information to the user terminal. In an example embodiment, the delivery module may be further configured to deliver the media content in the message using the user information, such as the phone number, internet address, internet protocol address, or a combination to the user terminal.

In an example embodiment of the invention, the media presentation request may be received with user information in a first connection, the media presentation may be delivered in the first connection, the media content request related to the media presentation may be received in the first connection, and the media content may be delivered in a second connection using or according to the user information to the user terminal. Further, the second connection to the user terminal may be initiated or established based on the user information. In an example embodiment, the receiver module may be further configured to receive the media presentation request with user information in the first connection, the delivery module may be further configured to deliver the media presentation in the first connection, the receiver module may be further configured to receive the media content request related to the media presentation in the first connection, and the delivery module may be configured to deliver the media content in the second connection using the user information to the user terminal. Further, the delivery module may be further configured to establish the second connection to the user terminal based on the user information.

Without in any way limiting the scope, interpretation, or application of the claims appearing below, it is possible that a technical effect of one or more of the example embodiments disclosed herein may be that the media presentation may be delivered in the first connection to the user terminal, for example, for promotional, marketing and/or advertising purposes, and that the user terminal may communicate an interest, such as a request to download and/or purchase an actual media content of the media presentation in the second connection while the first connection is still active or open.

Another possible technical effect of one or more of the example embodiments disclosed herein may be that the user information, such as the address of the user device or user, may be determined automatically in the first connection without any manual user feed back, and that later the address may be used provide the media content to the user terminal in the second connection.

Another possible technical effect of one or more of the example embodiments disclosed herein may be that the user information, such as the address of the user device or user, may be captured automatically by the communication access node, and the user information may be communicated to the media service node, that may use the address to find any existing user profile, user account, or billing information, if the user has created them or signed in the media service, to select suitable media content to the user, and to bill the user based on the billing information.

Another possible technical effect of one or more of the example embodiments disclosed herein may be that in case the user or user device does not have the profile in the media service node, the media service node may instruct the billing node to bill the media content in the user's communication service account.

Another possible technical effect of one or more of the example embodiments disclosed herein may be that the media presentation may be delivered over the telephonic communication, e.g. over the first communication, and the media content may be delivered over the message communication, e.g. over the second connection, to the same address that was determined from the telephonic communication, while the first communication is still active.

Another possible technical effect of one or more of the example embodiments disclosed herein may be that any communication access node, such as the PBXes, may be connected to the media service node, such as the iTunes™, to provide automatically to the user terminal, that may be connected to the communication access node, the media presentation and/or media content from the media service node meanwhile the user device may be the on-hold mode in the communication access node.

The one or more example embodiments of the present invention may be implemented in software, hardware, application logic or a combination of software, hardware and application logic. The software, application logic and/or hardware may reside on the user terminal, communication access node, or media service node. If desired, part of the software, application logic and/or hardware may reside on the user terminal, part of the software, application logic and/or hardware may reside on communication access node, and part of the software, application logic and/or hardware may reside on media service node. The application logic, software or an instruction set may be maintained on any one of various conventional computer-readable media. In the context of this document, a “computer-readable medium” may be any media or that may contain, store, communicate, propagate or transport the instructions for use by or in connection with an instruction execution system, apparatus, or device.

If desired, the different operations discussed herein may be performed in any order and/or concurrently with each other. Furthermore, if desired, one or more of the above-described operations may be optional or may be combined.

Although various aspects of the invention are set out in the independent claims, other aspects of the invention comprise a combination of features from the described one or more example embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is:

1. A method, comprising:
instructing a receiving of a media presentation over a first connection;
instructing a rendering of the media presentation; instructing a requesting over the first connection of media content related to the media presentation; and
instructing a receiving of a media content over a second connection.

2. A method according to claim 1, wherein the first connection is one of a phone call and an instant message connection, and receiving the media content in a message over the second connection.

3. A method according to claim 1, wherein in the media presentation is at least one of the following: a music presentation, video presentation, audio presentation, text presentation, media broadcasting, media multicasting, media unicasting, media streaming, multimedia presentation, map, advertisement, program file, and a combination thereof.

4. A method according to claim 1, wherein instructing the requesting of the media content further comprises instructing a sending of a media content request over the first communication, and wherein the media content is at least one of the following: a music file, video file, audio file, map file, game file, program file, text presentation, broadcast channel information, advertisement, link to the media content, and a combination thereof.

5. An apparatus, comprising:
at least one processor;
at least one memory including computer program code;
the at least one memory and the computer program code configured to, with the at least one processor, instruct the apparatus at least to peform:
instruct a receiving of a media presentation over a first connection;
instruct a rendering of the media presentation;
instruct a requesting over the first connection media content related to the media presentation; and
instruct a receiving of the media content over a second connection.

6. An apparatus according to claim 5 wherein in the first connection is one of a phone call and an instant message.

7 An apparatus according to claim 5, wherein in the media presentation is at least one of the following: a music presentation, video presentation, audio presentation, text presentation, media broadcasting, media multicasting, media unicasting, media streaming, multimedia presentation, map, advertisement, program file, and a combination thereof, and wherein the media content is at least one of the following: a music file, video file, audio file, map file, game file, text presentation, broadcast channel information, advertisement, link to the media content, and a combination thereof.

8 An apparatus according to claim 5, further instruct to receive the media content in a message over a second connection.

9 A method, comprising:
instructing a processing of a connection request;
instructing a determining of user information from the connection request;
instructing a delivering of a media presentation;
instructing a processing of a receiving of a media content request related to the media presentation;
instructing a delivering of a media content according to the user information; and
wherein the user information is at least one of the following: a phone number, email address and Internet protocol address.

10. A method according to claim 9, wherein
instructing a receiving of the connection request further over one of the following: phone call and instant messaging; and
instructing a delivering of a message over one of the following: a message connection and an instant messaging.

11. A method according to claim 9, wherein selecting the media presentation further comprising:
instructing the delivering of the media presentation request with the user information to a media service provider; and
instructing the receiving of the media presentation from the media service provider.

12. A method according to claim 9, wherein instructing the delivering of the media content further comprising instructing delivering of a media content request to a media service provider with instructions to send the media content according to the user information.

13. A method according to claim 9, wherein in the media presentation is at least one of the following: a music presentation, video presentation, audio presentation, text presentation, media broadcasting, media multicasting, media unicasting, media streaming, multimedia presentation, map, advertisement, and a combination thereof, and
wherein the media content is at least one of a music file, a video file, a audio file, a map file, a game file, a text presentation, an advertisement, broadcast channel information, an advertisement, and a link to the media content, and a combination thereof.

14. An apparatus, comprising:
at least one processor;
at least one memory including computer program code;
the at least one memory and the computer program code configured to, with the at least one processor, instruct the apparatus at least to peform:
instruct a receiving of a connection request;
instruct a determining of user information from the connection request;
instruct a delivery of a media presentation;
instruct a receiving of the media content request related to the media presentation;
instruct a delivery of a media content according to the user information; and
wherein the user information is at least one of the following: a phone number, email address and Internet protocol address.

15. An apparatus according to claim 14, further instruct
a receiving of the connection request over one of the following: a telephonic call and instant messaging: and
a delivery of the message over one of the following: a message connection and an instant messaging.

16. An apparatus according to claim 14, further instruct:
a delivery of the media presentation request with the user information to a media service provider; and
a receiving of the media presentation from the media service provider.

17. An apparatus according to claim 14, further instruct a delivery the media content request to a media service provider with instructions to send the media content according to the user information.

18. An apparatus according to claim 14, wherein in the media presentation is at least one of the following: a music presentation, video presentation, audio presentation, text presentation, media broadcasting, media multicasting, media unicasting, media streaming, multimedia presentation, map, advertisement, and a combination thereof, and
wherein the media content is at least one of the following: a music file, video file, audio file, map file, game file, text presentation, broadcast channel information, advertisement, a link to the media content, and a combination thereof.
